(19) United States
(12) Patent Application Publication
(10) Pub. No.: US 2017/0183101 A1
(43) Pub. Date: Jun. 29, 2017

(54) PAGOPHOBIC COATING COMPOSITIONS, METHOD OF MANUFACTURE AND METHODS OF USE

(71) Applicant: ARIZONA BOARD OF REGENTS ON BEHALF OF ARIZONA STATE UNIVERSITY, SCOTTSDALE, AZ (US)

(72) Inventors: KONRAD RYKACZEWSKI, TEMPE, AZ (US); XIAODA SUN, TEMPE, AZ (US); SUSHANT ANAND, LEXINGTON, MA (US); KRIPA VARANASI, LEXINGTON, MA (US)

(73) Assignee: ARIZONA BOARD OF REGENTS ON BEHALF OF ARIZONA STATE UNIVERSITY, SCOTTSDALE, AZ (US)

(21) Appl. No.: 15/127,753

(22) PCT Filed: Mar. 20, 2015
(86) PCT No.: PCT/US2015/021859

§ 371 Date: Sep. 20, 2016

(51) Int. Cl. B64D 15/00; C09D 163/00; C09D 183/16; C09D 177/00; C09K 3/18; C09D 5/00

(52) U.S. Cl. CPC B64D 15/00; C09K 3/18; C09D 5/00; C09D 183/16; C09D 177/00; C09D 163/00

(57) ABSTRACT

Some embodiments of the invention include a pagophobic coating assembly including a wick layer coupled an outer layer. The wick layer includes a fluid reservoir with an antifreeze material. The wick can be a hydrophilic or superhydrophilic material, and the outer layer can include a superhydrophobic or omniphobic material. In some embodiments, the wick includes a nylon-based polymer, and the outer layer includes a silicone or siloxane based polymer. In some embodiments of the invention, the antifreeze material includes an alkylene glycol. In some embodiments, the wick layer can enable the antifreeze material to migrate from the wick layer into the outer layer, and the outer layer is configured to enable the antifreeze to migrate to the upper surface of the outer layer. Some embodiments include an article of manufacture including the pagophobic coating assembly. Some further embodiments of the invention include a method of forming the pagophobic coating assembly.

### RELATED APPLICATIONS

This application claims priority from U.S. Patent Application No. 61/955,901 entitled “Multifunctional Coatings/Surfaces with Three Dimensional Spatial Heterogeneities in Wetting/Adhesion Properties” filed Mar. 20, 2014, and U.S. Patent Application No. 62/034,971 entitled “Pagophobic Coating Compositions, Method of Manufacture and Methods of Use” filed on Aug. 8, 2014, the entire contents of which are incorporated herein by reference.

### BACKGROUND

Frost and ice accumulation are a major safety and efficiency concern for aircraft, sea vessels, wind turbines, off-shore oil platforms, and other critical infrastructure. A common and effective way of preventing ice accretion is to dispense freezing point depressants. For example, prior to take-off in wintery conditions, airplanes are often sprayed with antifreeze liquids such as ethylene glycol. To prevent antifreeze depletion during flight, commercially available weeping wing systems can continuously dispense antifreeze over the wings through an active pumping system (see for example Ryerson in C. C., in “Assessment of superstructure ice protection as applied to offshore oil operations safety: ice protection technologies, safety enhancements, and development needs”, in Engineer research and development center, Hanover, N.H. cold regions research and engineering lab: 2009). For small airplanes, about 4 to 8 liters of the antifreeze liquid are dispensed per hour. However, the high cost of the active dispensing system and fairly large quantities of antifreeze make it unlikely to be adopted in other applications such as large airplanes and ships. Moreover, the complexity of these systems can limit their scalability for emerging miniaturized devices such as unmanned aerial vehicles.

In order to reduce the use of antifreeze, and eliminate complex dispensing systems, semi-porous coatings that wick in the antifreeze from a reservoir have been developed (see for example the Feltwick Grating in Ryerson, and Chang, Y. S., in Performance Analysis of Frostless Heat Exchanger by Spreading Antifreeze Solution on Heat Exchanger Surface. Journal of Thermal Science and Technology 2011, 6, (1), 123-131, and Chang, Y. S.; Yun, W. N., in An Experimental Study on the Frost Prevention using Micro Liquid Film of an Antifreeze Solution. International Journal of Air-Conditioning and Refrigeration 2006, 14, (2), 66-75). However, in these systems, the antifreeze can be rapidly diluted by rain or atmospheric precipitation, or by sea water spray created by spindrift spray ripped from tops of waves by wind, or by splashing of sea water against the ship (see Ryerson cited above).

As an alternative to active anti-icing systems, a number of passive bio-inspired coatings have been recently proposed; however, their functionality is often limited to a particular set of environmental conditions. Examples of such coatings include nanostructured superhydrophobic surfaces that slow ice accumulation by repelling sub-cooled water droplets, but when frosted over, increase ice accretion and adhesion (see for example Varanasi, K K; Deng, T; Smith, J. D.; Hsu, M.; Bhate, N., in “Frost formation and ice adhesion on superhydrophobic surfaces”, Applied Physics Letters 2010, 97, (23), 234102). Similarly, it was recently demonstrated that pagophobic functionality of lubricant-impregnated surfaces (LIS) can be compromised due to lubricant drainage into nucleating frost consisting of network on nano-iciles (see for example Rykaczewski, K.; Anand, S.; Subramanyam, S. B.; Varanasi, K. K., in “Mechanism of Frost Formation on Lubricant Impregnated Surfaces”, Langmuir 2013, 29, (17), 5230-5238).

Accordingly, there exists a need to provide surfaces or coating technologies that provide pagophobic and anti-icing functionality for structures and vehicles of all sizes operating in a wide range of environmental conditions on land, on the sea, and in the air.

### SUMMARY

Some embodiments of the invention include a pagophobic coating assembly comprising a wick layer comprising an interior volume bounded by a first side and a second side, and an outer layer at least partially coupled to the wick layer. The outer layer comprises a volume bounded by a lower surface and an upper surface, and the lower surface is at least partially coupled to the second side. The pagophobic coating assembly includes at least one fluid reservoir positioned in at least a portion of the wick layer, and the at least one fluid reservoir includes an antifreeze material.

In some embodiments of the invention, the at least one reservoir comprises a porosity. In some embodiments, the porosity comprises a continuous porosity. In other embodiments, the porosity comprises a discontinuous porosity

In some embodiments of the invention, the wick comprises a hydrophilic or superhydrophilic material. In some embodiments, the wick comprises a nylon-based polymer. In some embodiments of the invention, the wick comprises at least one of a Poly(N-isopropylacrylamide) polymer, a Polyacrylamide based polymer, a Poly(2-oxazoline) based polymer, a Polyethylenimine based polymer, a Poly(acrylic acid) based polymer, an acrylic based polymer including a Polymethacrylate based polymer, a Poly(ethylene glycol) based polymer, a Poly(ethylene oxide) based polymer, a Poly(vinyl alcohol) based polymer, and a Poly(vinylpyrrolidone) based polymer.

In some embodiments, the outer layer comprises a superhydrophobic or omniphobic material. In some embodiments, the outer layer comprises silicone or siloxane based polymer. In some further embodiments, the outer layer comprises a fluorosilane based polymer.

Some embodiments of the invention include an antifreeze material that comprises an alkylene glycol. In some further embodiments, the antifreeze material comprises at least one of a water soluble alcohol, a dicarboxylic acid or salt of a dicarboxylic acid, and an antifreeze protein.

In some embodiments of the invention, the first side is coupled to an outer surface of a substrate. In some embodiments, the second side comprises the outer layer. In some embodiments, at least a portion of the wick layer is configured to enable the antifreeze material to migrate from the interior volume into the volume of the outer layer, and the outer layer is configured to enable the antifreeze to migrate to the upper surface.

An article of manufacture including a pagophobic coating comprising a good comprising an outer surface, a wick layer coupled to the outer surface, where the wick layer comprises an interior volume bounded by a first side and a second side, and an outer layer coupled to the wick layer. The outer layer comprises a volume bounded by a lower surface and an upper surface, and the lower surface is at least partially coupled to the second side. The pagophobic coating comprises at least one fluid reservoir positioned in at least a portion of the wick layer, where the at least one fluid reservoir includes an antifreeze material. Further, the wick layer and outer layer are configured and arranged to enable the antifreeze material to migrate from the interior volume and through the volume of the outer layer to the upper surface.

Some embodiments of the invention include a method of forming a pagophobic coating assembly comprising providing a wick layer comprising an interior volume including at least one fluid reservoir, and coupling an outer layer to the wick layer. The outer layer comprises a volume bounded by a lower surface and an upper surface, and the lower surface is at least partially coupled to the wick layer. The method also comprises infusing an antifreeze material into the at least one fluid reservoir, where the wick layer is configured to enable the antifreeze material to migrate from the interior volume to the upper surface. Further, the antifreeze material can be resupplied using an active pumping device.

In some embodiments of the method, the wick layer comprises a hydrophilic or superhydrophilic material and the outer layer comprises a superhydrophobic or omniphobic material.

In some further embodiments of the method, the at least a portion of the outer layer is rendered hydrophilic when coupled with moisture comprising at least one of liquid water, frost, rime and glaze.

In some other embodiments of the method, at least a portion of the wick layer is configured to enable at least a portion of the antifreeze material to migrate into any hydrophilic portion of the outer layer.

### DESCRIPTION OF THE DRAWINGS

FIG. 1A is a cross-sectional view of a pagophobic coating assembly according to some embodiments of the invention.

FIG. 1B is a cross-sectional view of a pagophobic coated surface according to some embodiments of the invention.

FIG. 1C is a cross-sectional view of the pagophobic coating assembly of FIG. 1A illustrating water repellent properties according to some embodiments of the invention.

FIG. 1D is a cross-sectional view of the pagophobic coated surface of FIG. 1B illustrating water repellent properties according to some embodiments of the invention.

FIG. 2A is an SEM view of a surface of a wick layer comprising superhydrophilic substrate in accordance with at least one embodiment of the invention.

FIG. 2B is a close-up view of a portion of the superhydrophilic substrate shown in FIG. 2A in accordance with at least one embodiment of the invention.

FIG. 2C is a close-up view of a portion of a superhydrophilic substrate including a superhydrophobic coating in accordance with at least one embodiment of the invention.

FIG. 3A is a close-up cross-sectional view of a portion of a pagophobic coating illustrating condensation in accordance with some embodiments of the invention.

FIG. 3B is a close-up cross-sectional view of a portion of a pagophobic coating illustrating de-sublimation and condensation frosting in accordance with some embodiments of the invention.

FIG. 3C is close-up cross-sectional view of a portion of a pagophobic coating illustrating antifreeze release subsequent to the de-sublimation and condensation frosting illustrated in FIG. 3B in accordance with some embodiments of the invention.

FIG. 3D is close-up cross-sectional view of a portion of a pagophobic coating illustrating water and antifreeze departure subsequent to the antifreeze release illustrated in FIG. 3C in accordance with embodiments of the invention.

FIG. 4A shows an image of a plurality of water droplets positioned on the surface of a wick layer comprising superhydrophilic substrate including a superhydrophobic coating in accordance with at least one embodiment of the invention.

FIG. 4B shows an image of a close-up side view of a water droplet resting on the surface of a wick layer comprising superhydrophilic substrate infused with antifreeze including a superhydrophobic coating in accordance with at least one embodiment of the invention.

FIG. 5A shows an image of a surface of a wick layer comprising superhydrophobic surface and infused with an antifreeze material prior to cooling and misting in accordance with some embodiments of the invention.

FIG. 5B shows an image of a surface of a wick layer comprising superhydrophobic surface and infused with an antifreeze material and subjected to cooling and misting for 10 minutes in accordance with some embodiments of the invention.

FIG. 5C shows an image of a surface of a wick layer comprising superhydrophobic surface and infused with an antifreeze material and subjected to cooling and misting for 20 minutes in accordance with some embodiments of the invention.

FIG. 5D shows an image of a surface of a wick layer comprising superhydrophobic surface and infused with an antifreeze material and subjected to cooling and misting for 30 minutes in accordance with some embodiments of the invention.

FIG. 6A shows a close up image of a surface of the region R of FIG. 5D of a superhydrophobic surface and infused with an antifreeze material and subjected to cooling and misting for 60 minutes in accordance with some embodiments of the invention.

FIG. 6B shows a close up image of a surface of the region R of FIG. 5D of a superhydrophobic surface and infused with an antifreeze material and subjected to cooling and misting for 100 minutes in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Described herein are multifunctional coatings, layers, and/or surfaces that can comprise three dimensional (hereinafter “3D”) heterogeneities. The multifunctional coatings, layers, and/or surfaces can be used to form at least a portion of a surface or substrate that comprises pagophobic properties. Further, the multifunctional coatings, layers, and/or surfaces can be used to render at least a portion of a non-pagophobic surface or substrate pagophobic. As used herein, a surface or substrate exhibiting a pagophobic characteristic and/or pagophobic properties can be any surface or substrate that prevents, inhibits, or delays the nucleation and/or growth of one or more frost or ice crystals. Further, as used herein, frost can comprise any number of ice particles or ice crystals that can be at least partially coupled to at least a portion of a surface. The ice crystals can form via different routes such as, for example, frosting, condensation frosting, misting/fog freezing, or larger droplet impingement as in freezing rain.

In some embodiments of the invention described herein, the pagophobic surface or substrate formed by the methods described herein can be substantially continuous. In other embodiments, the pagophobic surface formed by the methods described herein can be substantially discontinuous. For example, in some embodiments, using the methods of forming multifunctional coatings, layers, and/or surfaces described herein, the treated surface or substrate can include surfaces that are pagophobic only, or can include surfaces that include regions that are pagophobic and regions that are non-pagophobic.

In some embodiments, a pagophobic surface can be achieved by modification of the architecture (i.e., the structure and morphology) of at least a portion of a surface or substrate. In some embodiments, this can be achieved by selective modification of the surface through texturing the surface. In some embodiments, the surface texturing can comprise modification of a surface to form a texture comprising substantially uniform or non-uniform regions with micron, sub-micron, and/or nanoscale dimensions. In some embodiments, the surface texturing can be formed by physical modification (e.g., mechanical abrasion, deformation, or roughening). In some further embodiments, a pagophobic surface can be achieved by chemical modification. In some embodiments, the chemical modification can include the use of spatially confined fluid phases (e.g., gas or liquid, or mixtures thereof).

Some embodiments of the invention can include multilayer coating surfaces with heterogeneous layer characteristics. These multilayer coatings or assemblies can comprise non-interacting (i.e. static) or responsive (i.e. dynamic) interactions between the different 3D spatial regions and an external medium (which can include gas, liquid, or solid phases).

Some embodiments of the invention described herein can include coatings, surfaces, layers, and assemblies that can offer superior performance in variety of applications including, but not being limited to, condensation, boiling, pagophobic/icing, anti-fouling (biological and chemical, e.g. salt or soot), and chemical resistance/defense.

Some embodiments of the invention generally comprise multifunctional coatings, surfaces, layers, and assemblies that comprise 3D spatial heterogeneous wetting and adhesion properties. The various embodiments of coatings, surfaces, layers, and assemblies as described herein can be applied to most any surface including, but not limited to, metal surfaces, polymer surfaces, glass surfaces, inorganic oxide surfaces, ceramic surfaces, composite material surfaces, materials of natural origin (such as wood or wood products), and surfaces including other coatings (e.g., paints or lacquers). Further, the multifunctional coatings, surfaces, layers, and assemblies described herein can be applied to and/or can conform to any shape or structure, including planar surfaces, curved or bent surfaces, smooth surfaces, uneven or rough surfaces, or combinations thereof.

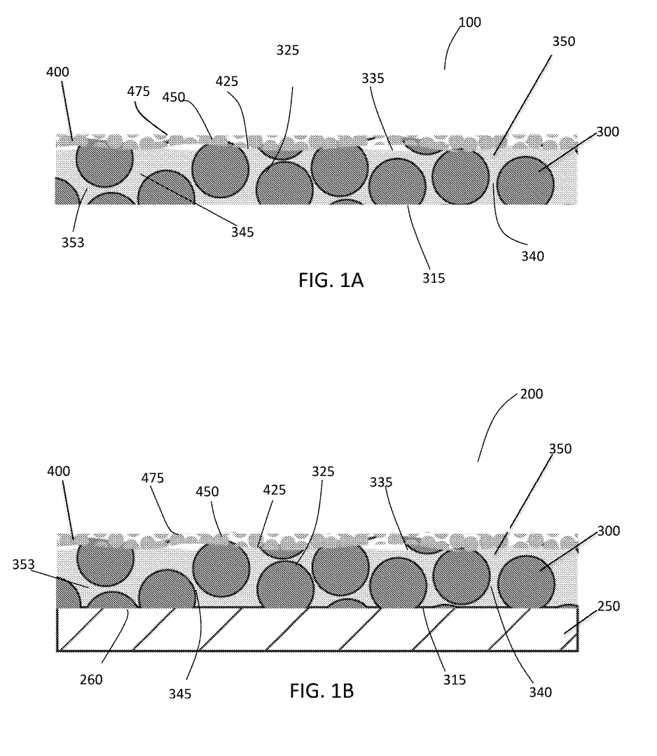

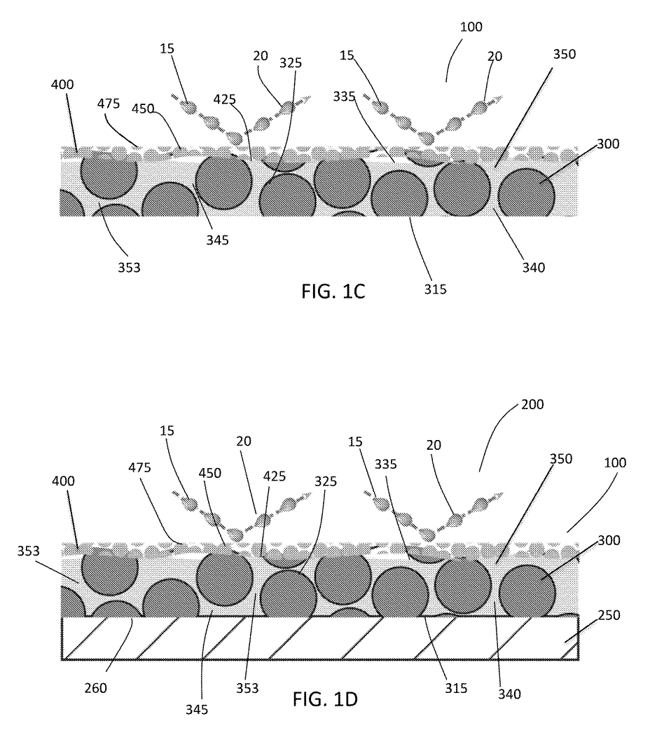

Example embodiments of multifunctional coatings and/or assemblies with 3D spatial heterogeneities as described above can be seen in FIGS. 1A-1D, 2A-2C, 3A-3D, 4A-4B, 5A-5D, and 6A-6B. For example, FIG. 1A is a cross-sectional view of a pagophobic coating assembly 100 according to some embodiments of the invention. In some embodiments, a pagophobic coating assembly 100 can comprise a dual layer superhydrophobic/superhydrophilic antifreeze infused structure. For example, in some embodiments, the pagophobic coating assembly 100 can comprise at least one wick layer 300 and at least one outer layer 400. The wick layer 300 can include at least a first side 315 and a second side 335, with an interior volume 325 between the first and second sides 315, 335. In some embodiments, the wick layer 300 can be formed from and/or comprise a hydrophilic or superhydrophilic material and/or can include an outer surface (either the first side 315 and a second side 335) that is hydrophilic or superhydrophilic. In some embodiments, the superhydrophilic wick layer 300 layer can comprise any conventional nylon filter modified with a spray-on polymeric superhydrophobic coating (forming an outer layer 400). In some further embodiments, the wick layer 300 can comprise a superhydrophilic nylon polymer with vapor deposited superhydrophobic coating (forming the outer layer 400).

A variety of materials can be used to form the superhydrophilic wick layer 300 and the superhydrophobic outer layer 400. For example, in addition to the aforementioned nylon material, the wick layer 300 can comprise any hydrophilic or superhydrophilic polymer, including, but not limited to nylon-based homopolymers, nylon-based copolymers, nylon-based polymer blends, Poly(N-isopropylacrylamide) and Polyacrylamide based polymers and copolymers, Poly(2-oxazoline) and Polyethylenimine based copolymers, acrylic-based polymers and copolymers including Poly(acrylic acid), Polymethacrylate, Poly(ethylene glycol) and Poly(ethylene oxide) based polymers and copolymers, Poly(vinyl alcohol) (PVA) based copolymers, and Poly(vinylpyrrolidone) based copolymers.

In some embodiments of the invention, the wick layer 300 can include porosity 340 comprising one or more voids 345. Further, in some embodiments, the voids 345 can form at least one reservoir 353 capable of holding or retaining fluid. In some embodiments of the invention, the wick layer 300 can be infused with at least one material capable of depressing the freezing point of water. In some embodiments, the wick layer 300 can be infused with at least one fluid capable of affecting the frost or freeze behavior of the wick layer 300 and/or the at least one outer layer 400. For example, in some embodiments of the invention, the wick layer 300 can be infused with at least one material comprising antifreeze properties, characteristics, or behavior (shown as antifreeze material 350). The antifreeze material 350 can comprise any material capable of depressing the freezing point of water. Moreover, the antifreeze material 350 can comprise any material capable of movement, flow, or migration within the wick layer 300 or out of the wick layer 300 (e.g., to a surface of the wick layer 300 and/to another coupled coating or layer).

In some embodiments, the antifreeze material 350 can comprise at least one alkylene glycol (such as ethylene glycol and/or propylene glycol) or derivatives thereof, glycerol, at least one glycol containing polymer, or mixtures thereof In some embodiments, the antifreeze material 350 can comprise at least one antifreeze composition containing a water-soluble liquid alcohol. In some embodiments, the antifreeze material 350 can comprise one or more dicarboxylic acids, or salts thereof In some other embodiments, the antifreeze material 350 can comprise an anti-freeze protein.

In some embodiments, the pagophobic coating assembly 100 can comprise at least one outer omniphobic shell, layer, or coating positioned adjacent, proximate, and/or coupled to the at least one wick layer 300. As shown in at least FIG. 1A, in some embodiments, the pagophobic coating assembly 100 can comprise at least one outer layer 400 coupled to the at least one wick layer 300. In some embodiments, the outer layer 400 can comprise at least a lower surface 425, an upper surface 475, and a volume 450 between the upper and lower surfaces 475, 425. In some embodiments, the outer layer 400 can comprise a permeable outer omniphobic shell, layer, or coating that can form a superhydrophobic surface.

In some embodiments, the pagophobic coating assembly 100 can comprise a free standing layer, shell, or coating. In some further embodiments, the pagophobic coating assembly 100 can be applied (e.g., positioned adjacent, proximate, and/or coupled to) another surface or substrate. In some other embodiments, the pagophobic coating assembly 100 can be formed or assembled positioned adjacent or proximate a surface or substrate and/or formed onto a surface or substrate. For example, FIG. 1B is a cross-sectional view of a pagophobic coated surface 200 according to some embodiments of the invention. As illustrated, in some embodiments of the invention, the pagophobic coated surface 200 can comprise a substrate 250 including a pagophobic coating assembly 100 adjacent or coupled to an outer surface 260 of the substrate 250. In some embodiments of the invention, the pagophobic coating assembly 100 can be applied (e.g., positioned adjacent, or proximate, and/or coupled) to the outer surface 260 of the substrate 250. In some further embodiments, the pagophobic coating assembly 100 can be formed onto the outer surface 260 of the substrate 250. For example, in some embodiments, at least one wick layer 300 and at least one outer layer 400 can be coupled to the outer surface 260 of the substrate 250. In some embodiments, a first side 315 of the wick layer 300 can be coupled to the outer surface 260. In some embodiments, the pagophobic coating assembly 100 can be applied to an article of manufacture. For example, in some embodiments, a good comprising the substrate 250 can be treated with the pagophobic coating assembly 100 so that at least a portion of the good comprises the pagophobic coated surface 200.

In some embodiments, wick layer 300 coupled to the outer surface 260 of the substrate 250 can be infused with at least one material capable of depressing the freezing point of water formed or impacting the upper surface 475. In some embodiments, the wick layer 300 coupled to the outer surface 260 of the substrate 250 can be infused with at least one of the aforementioned the antifreeze materials 350. Further, in some embodiments, at least one outer layer 400 can be formed, applied and coupled to the wick layer 300 coupled to the outer surface 260 prior to the wick layer 300 being infused with at least one of the aforementioned the antifreeze materials 350.

The substrate 250 of the various embodiments described herein can include metal substrates, polymer substrates, glass substrates, inorganic oxide substrates, ceramic substrates, composite material substrates, substrate materials of natural origin (including cellulosic substrates such as wood or wood products), and substrates including surfaces with coatings (e.g., paints or lacquers). The substrate 250 can include planar substrates, curved or bent substrates, smooth substrates, uneven or rough substrates, or combinations thereof Further, the multifunctional coatings, surfaces, layers, and assemblies described herein can be applied to and/or can conform to any shape or structure of the substrate 250, including planar surfaces of the substrate 250, curved or bent surfaces of the substrate 250, smooth surfaces of the substrate 250, uneven or rough surfaces of the substrate 250, or combinations thereof.

In some embodiments, the outer layer 400 coupled to the wick layer 300 can serve several functions. For example, in some embodiments, the outer layer 400 can serve as a separator between the antifreeze material 350 and the environment. Consequently, in some embodiments, in the absence of frost or condensation, the outer layer 400 can prevent ice accumulation by repelling impinging droplets. For example, FIG. 1C is a cross-sectional view of the pagophobic coating assembly 100 of FIG. 1A illustrating water repellent properties according to some embodiments of the invention, and FIG. 1D is a cross-sectional view of the pagophobic coated surface 200 of FIG. 1B illustrating water repellent properties according to some embodiments of the invention. In some embodiments, incoming droplets 15 with some velocity can impact the upper surface 475 of the outer layer 400 and be deflected as deflected droplets 20. The outer porous coating can also suppress condensation or formation of frost. These two processes almost always simultaneously with freezing rain and can dramatically increase adhesion of impinging drops. The superhydrophobic coating (outer layer 400) can be viewed as an array of nano- or micro-scale pores partially filled with hygroscopic antifreeze material 350. These patterned “humidity sinks” (antifreeze materials 350 such as glycols are desiccants) decrease water vapor concentration between the surface pores, decreasing probability for nucleation of drops or frost.

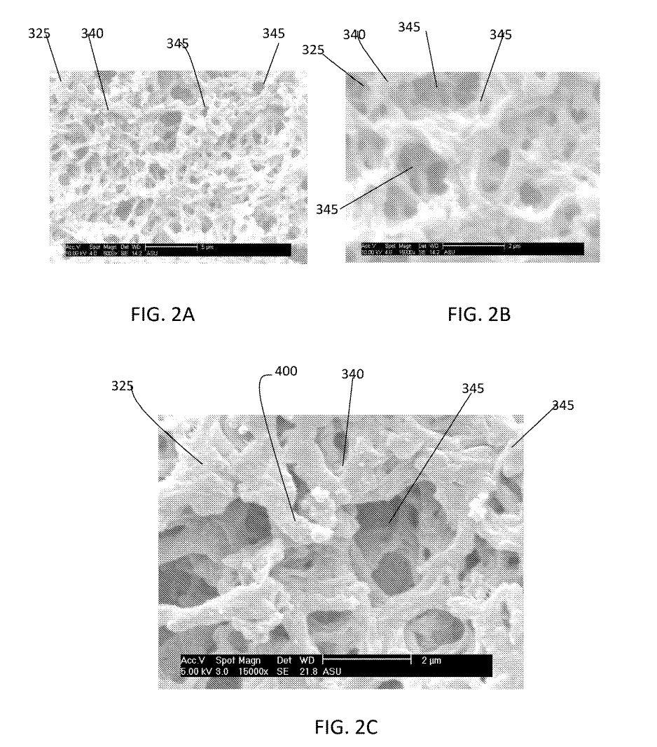

In some embodiments, the wick layer 300 can include porosity 340 that comprises substantially continuous or discontinuous porosity. For example, in some embodiments, the wick layer 300 can comprise a continuous porosity (e.g., voids 345 that are continuous connected). In some other embodiments, the wick layer 300 can comprise a discontinuous porosity (e.g., voids 345 that are separated). In some further embodiments, the wick layer 300 can comprise a heterogeneous structure including both regions of continuous porosity, and regions of discontinuous porosity. For example, FIG. 2A is an SEM view of a surface of a wick layer 300, and FIG. 2B is a close-up view of a portion of the wick layer 300 shown in FIG. 2A in accordance with at least one embodiment of the invention. In some embodiments, the wick layer 300 can comprise porosity 340 including voids 345 in the sub-nanometer-sized range. In some further embodiments, the wick layer 300 can comprise porosity 340 including voids 345 that are nanometer-sized in diameter. In some other embodiments, the wick layer 300 can comprise porosity 340 including voids 345 are submicron in diameter. In some alternative embodiments, the wick layer 300 can comprise porosity 340 including voids 345 that comprise a diameter of about one micron. In some further embodiments, the wick layer 300 can comprise porosity 340 including voids 345 with a diameter greater than about a micron. In some embodiments of the invention, at least one reservoir 353 can comprise voids 345 with any one or combination of any or all of the above described diameters.

In some embodiments, at least a portion of the wick layer 300 can be modified to form a pagophobic surface. For example, in some embodiments, the structure, morphology, and/or chemistry of at least a portion of the wick layer 300 can be changed to render it superhydrophobic. For example, in the above mentioned example, a wick layer 300 comprising a superhydrophilic nylon polymer can include vapor deposited superhydrophobic coatings (forming the outer layer 400). In some embodiments, the superhydrophobic coatings can comprise superhydrophobic nanoparticle coatings from Integrated Surface Technologies Incorporated (IST Inc.), 1455 Adams Drive, Suite 1125, Menlo Park, Calif. 94025. In some further embodiments, a spray-on polymeric superhydrophobic coating from Hydrobead (see www.hydrobead.com). In some embodiments, the superhydrophobic coating can comprise a silicone or siloxane polymer. Some embodiments can include a superhydrophobic coating comprising at least one halosilane. Some embodiments can include halogenated polymers (e.g., fluorosilicone). Some further embodiments can comprise halo-silane based polymers. Some embodiments can include epoxy matrix materials with hydrophobic nanoparticle additives such as, but not limited to, fumed silica, Polytetrafluoroethylene, nanocarbons, and siloxanes.

In some embodiments, the outer layer 400 comprising a superhydrophobic coating can be formed by selective modification of the wick layer 300 through texturing the surface at the micron, sub-micron, and/or nanoscale regime. For example, in some embodiments, at least some fraction of the wick layer 300 can be rendered at least partially frost-resistant by texturing the surface of the wick layer 300 at the sub-nanometer-sized range. In some further embodiments, at least some fraction of the surface of the wick layer 300 can be can be rendered at least partially frost-resistant by modifying and/or texturing at the nanometer-sized range. In some other embodiments, at least some fraction of the surface of the wick layer 300 can be rendered at least partially frost-resistant by modifying and/or texturing at the submicron-sized range and/or micro-sized range. In some further embodiments, at least some fraction of the surface of the wick layer 300 can be rendered at least partially frost-resistant by modifying and/or texturing in a range that includes sizes above about a micron. For example, FIG. 2C is a close-up view of a portion of a wick layer 300 comprising a superhydrophilic substrate including an outer layer 400 comprising a superhydrophobic coating. As illustrated, at least some portions of the surface can include a sub-micron and/or a nanophase layer.

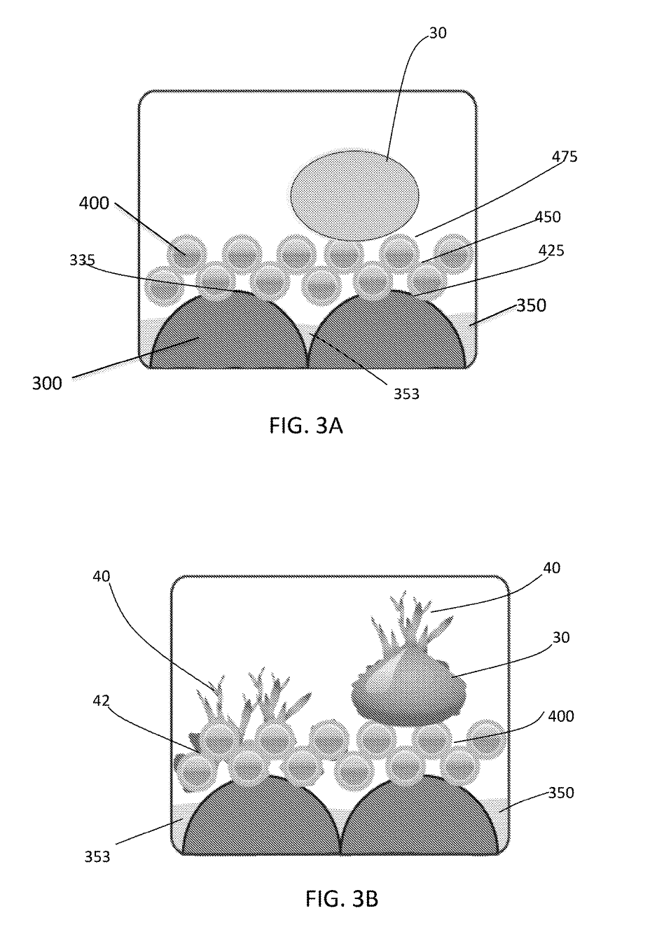

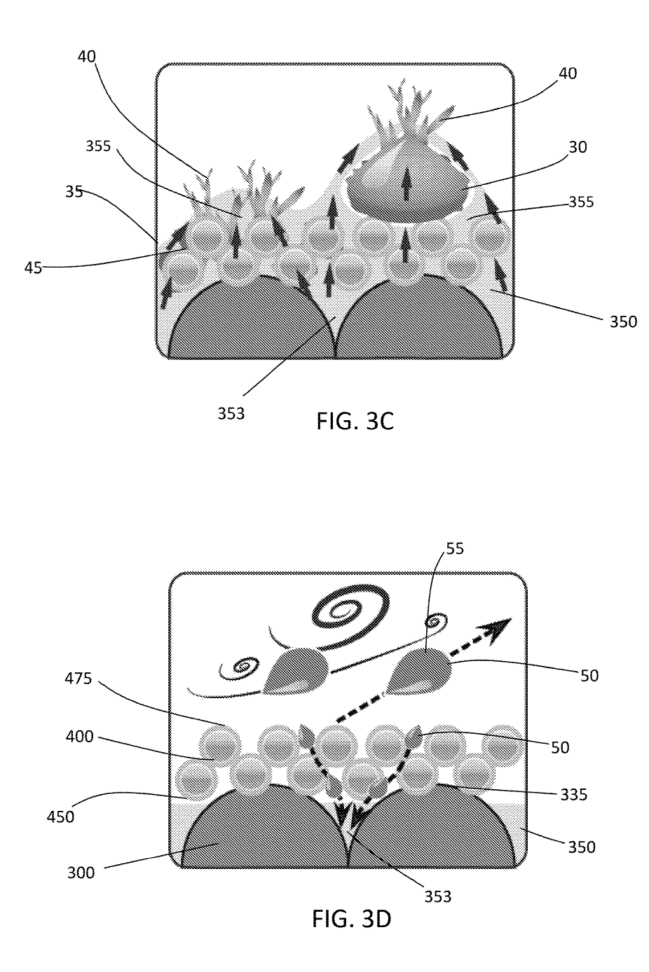

In some embodiments, when atmospheric conditions result in condensation frosting or desublimation, the outer layer 400 can become temporarily hydrophilic due to accumulation of frost and ice (see FIGS. 3A-3B). For example, FIG. 3A is a close-up cross-sectional view of a portion of a pagophobic coating illustrating condensation (surface droplet 30) in accordance with some embodiments of the invention. The example embodiments includes an illustration of a pagophobic coating that can be at least a portion of the pagophobic coating assembly 100 shown in FIGS. 1A and 1C and/or at least a portion of the pagophobic coated surface 200 shown in FIGS. 1B and 1D. Further FIG. 3B is a close-up cross-sectional view of a portion of a pagophobic coating illustrating de-sublimation and condensation frosting 40 in accordance with some embodiments of the invention. In this example, it can be seen that the pagophobic/icing function of this pagophobic coating can be achieved through preferential infusion of the bottom superhydrophilic layer (the wick layer 300) with antifreeze material 350. In some embodiments, infusion of the antifreeze material 350 into the wick layer 300 can cause the antifreeze material 350 to be positioned in one or more voids 345 forming at least one reservoir 353. Further, in some embodiments, wicked moisture 42 can pass into and through the outer layer 400 in some embodiments. For example, in some embodiments, absorption of moisture (i.e., absorption of the surface droplet 30 shown in FIG. 3A forming the wicked moisture 42 shown in FIG. 3B) onto the outer layer 400 can wet at least a portion of the underlying outer layer 400, and resulting in at least a portion of the outer layer 400 becoming less superhydrophobic, and more hydrophilic. In this instance, a stimulus adaptive wettability mechanism can lead to secretion of the antifreeze material 350 out of the outer layer 400 in response to frost formation over at least a portion of the outer layer 400. In some embodiments, if condensation leads to flooding of the superhydrophobic or omniphobic outer layer, antifreeze can also mix with the condensate via diffusion, depressing the freezing point of the solution. In other embodiments, high velocity drops can partially penetrate the outer coating 400, leading to release of antifreeze material 350 through diffusive mixing of the antifreeze material 350 and drop.

In some embodiments, at least some portion of the antifreeze material 350 can travel back out of the wick layer 300 and into and/or through at least a portion of the outer layer 400. In some embodiments, this can occur based on absorption of moisture on the surface of the coating (shown in FIG. 3B). For example, FIG. 3C is close-up cross-sectional view of a portion of a pagophobic coating illustrating release of antifreeze material 350 subsequent to the de-sublimation and condensation frosting 40 illustrated in FIG. 3B in accordance with some embodiments of the invention. In some embodiments, at least some portion of the antifreeze material 350 can migrate through and out of the wick layer 300 and into and/or through at least a portion of the outer layer 400. In some embodiments, the antifreeze material 350 can mix with wicked moisture 42 (e.g., to form a water-antifreeze region 45).

In some embodiments, antifreeze material 350 mixing with the frost layer (frost 40) can depress the freezing point of water, and cause melting and eventual removal of frost from the outer layer 400 via droplet shedding and/or wicking into a superhydrophilic region of the wick layer 300. For example, FIG. 3D is close-up cross-sectional view of a portion of a pagophobic coating illustrating water and antifreeze material 350 departure process subsequent to the antifreeze material 350 release illustrated in FIG. 3C in accordance with embodiments of the invention. As illustrated, in some embodiments, removal of the water-antifreeze mixture 50 from the water-antifreeze region 45 can occur through droplet shedding or wicking into a portion of the wick layer 300 (shown as water-antifreeze droplets 55). Further, in some embodiments, in case of extreme icing of the surface, the release of antifreeze material 350 can lead to formation of a thin lubricating water layer with a suppressed freezing point that can easily shed the frost 40. If fully iced over, the thin lubricating water-antifreeze layer will decrease ice adhesion to the surface, making it easy to remove. In practice, the frost-melt will either be removed through air motion (such as when used on an airplane wing) or be partially wicked into the wick layer 300. In some embodiments, a small volume of the antifreeze material 350 can be sacrificial. In some further embodiments, the antifreeze material 350 can be replenished over time. For example, in some embodiments, antifreeze material 350 can be intermittently or continuously supplied to a portion of the wick layer 300 using any conventional fluid delivery apparatus.

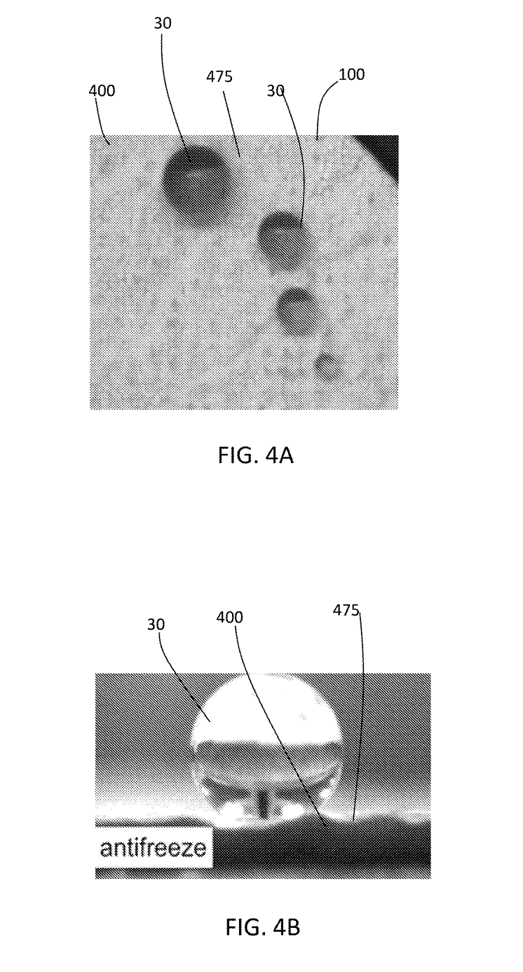

FIG. 4A shows an image of a plurality of water droplets 30 positioned on the surface of a wick layer 300 comprising superhydrophilic substrate including a superhydrophobic coating (outer layer 400 with upper surface 474) in accordance with at least one embodiment of the invention. Further, FIG. 4B shows an image of a close-up side view of a water droplet 30 resting on the surface of a wick layer 300 comprising superhydrophilic substrate infused with antifreeze material including a superhydrophobic coating (outer layer 400) in accordance with at least one embodiment of the invention. In these example embodiments, the surface droplets 30 comprise high contact angle water droplets positioned on top of a coating comprising the aforementioned superhydrophobic-superhydrophilic layers infused with an antifreeze material 350 comprising propylene glycol. As clearly illustrated by the high contact angle, the superhydrophobic coating (outer layer 400) can prevent direct contact between the surrounding wick layer 300 and the antifreeze material 350. Thus, this type of coating architecture can retain the superhydrophobic surface functionality needed for delaying rime, glaze, and sea spray ice formation by repelling impinging water droplets. In some embodiments, in the case of high velocity droplet impingement, at least a portion of the droplet 30 can at least partially penetrate the outer layer pores of the outer layer 400 (i.e., penetrating the upper surface 475), transitioning into “stuck” Wenzel state drops. In this case, the antifreeze material 350 can mix with the droplet 30 via diffusion, depressing the freezing point of the solution.

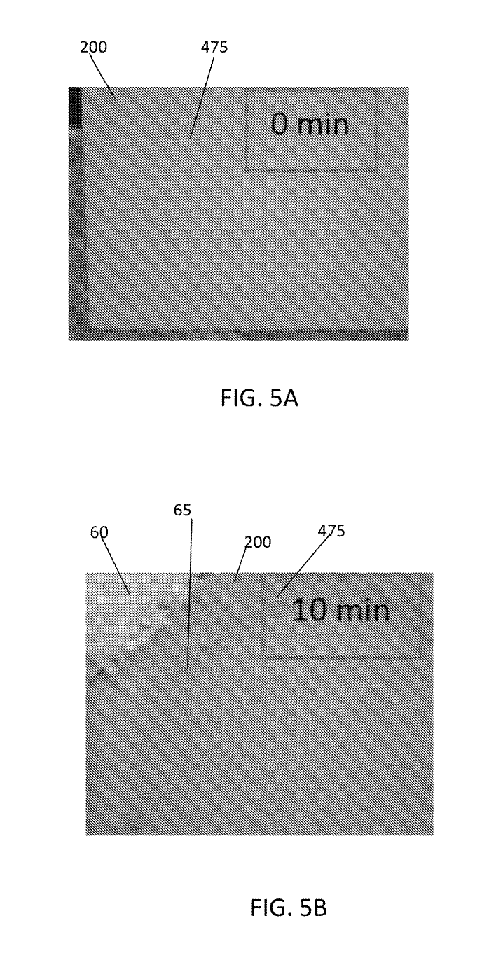

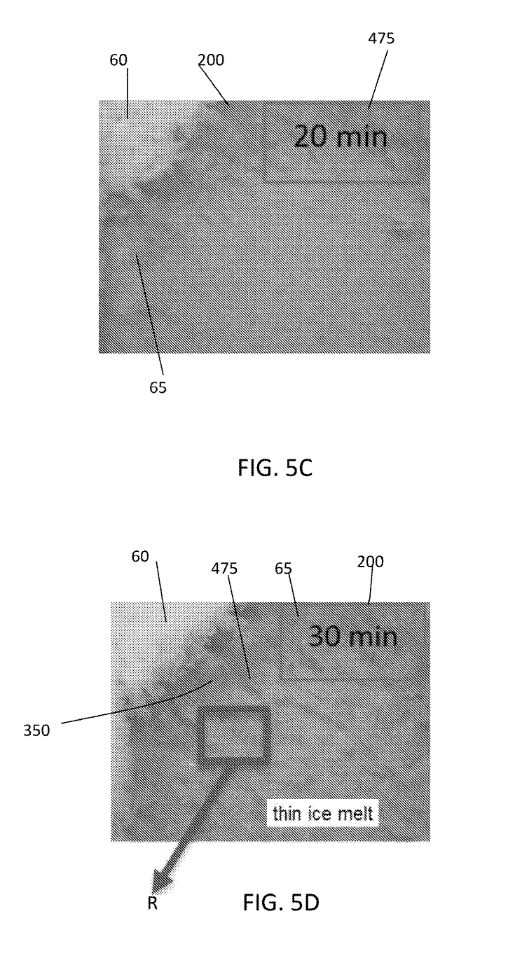

Experiments to demonstrate the aforementioned antifreeze secretion mechanism in response to frost formation (illustrated in FIG. 3C) have been performed using at least one of the embodiments described herein. Specifically, experiments have imaged condensation frosting of a wick layer 300. The samples were mounted to a water cooled Peltier element inside of an environment chamber with controlled humidity and temperature. Condensation frosting was achieved by decreasing the sample temperature to −10° C. in 60% relative humidity. For example, FIG. 5A shows an image of a surface of a wick layer 300 including an outer layer 400 comprising a superhydrophobic surface and infused with an antifreeze material 350 prior to cooling and misting. Further, FIG. 5B shows an image of a surface of a wick layer 300 including an outer layer 400 comprising a superhydrophobic surface and infused with an antifreeze material 350 and subjected to cooling and misting for 10 minutes in accordance with some embodiments of the invention. Further, FIG. 5C shows an image of a surface of a wick layer 300 including an outer layer 400 comprising a superhydrophobic surface and infused with an antifreeze material 350 and subjected to cooling and misting for 20 minutes. Further, FIG. 5D shows an image of a surface of a wick layer 300 including an outer layer 400 comprising a superhydrophobic surface and infused with an antifreeze material 350 and subjected to cooling and misting for 30 minutes in accordance with some embodiments of the invention. As illustrated, any frost 60 that forms on the surface (upper surface 475 of the outer surface 400) is quickly mixed with antifreeze material 350 secreted from the wick layer 300 through the outer layer 400. The antifreeze material 350 is visible in the frost-melt 65 layer shown in FIG. 5D after 30 minutes of experiment. In the top-left corner of the images shown in FIGS. 5C and 5D, the thick frost 60 is shown accumulated on an uncoated portion of the wick layer 300 that does not include an outer layer 400. This can be compared with the frost-melt 65 layer on the upper surface 475 of the outer surface 400 in the remainder of the image that includes the outer layer 400 comprising the superhydrophobic surface.

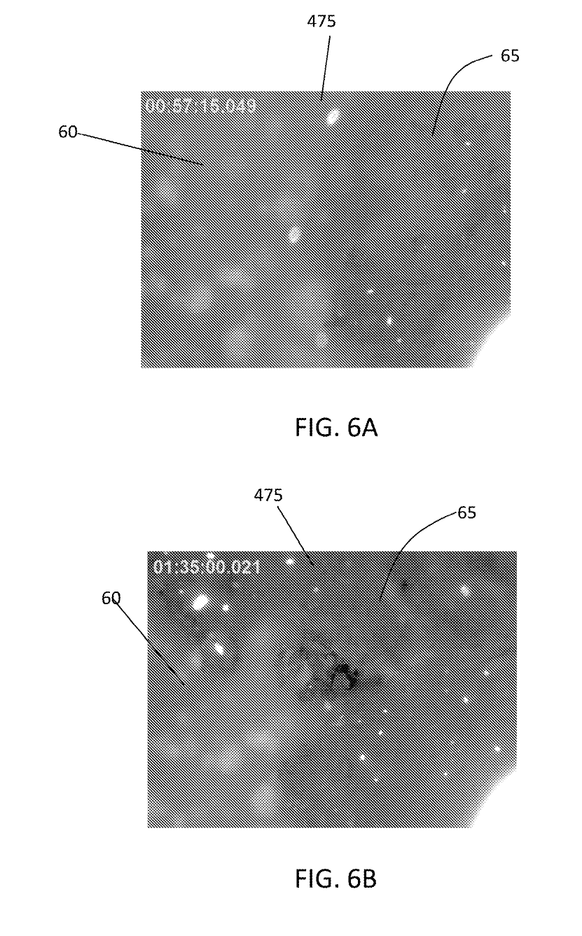

FIG. 6A shows a close up image of the region R of FIG. 5D of a wick layer 300 comprising a superhydrophobic surface and infused with an antifreeze material 350 and subjected to cooling and misting for 60 minutes, and FIG. 6B shows a close up image of the region R of FIG. 5D of a wick layer 300 comprising a superhydrophobic surface and infused with an antifreeze material and subjected to cooling and misting for 100 minutes in accordance with some embodiments of the invention. As the images in FIGS. 6A and 6B demonstrate, the wick layer 300 comprising a superhydrophobic surface and infused with the antifreeze material 350 can continue to secrete antifreeze material 350 and remain substantially frost-free for at least 100 minutes under the experimental conditions described above.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A pagophobic coating assembly comprising:
a wick layer comprising an interior volume bounded by a first side and a second side;
an outer layer at least partially coupled to the wick layer, the outer layer comprising a volume bounded by a lower surface and an upper surface, the lower surface at least partially coupled to the second side; and
at least one fluid reservoir positioned in at least a portion of the wick layer, the at least one fluid reservoir including an antifreeze material.

2. The pagophobic coating assembly of claim 1, wherein the at least one reservoir comprises a porosity.

3. The pagophobic coating assembly of claim 2, wherein the porosity comprises a continuous porosity.

4. The pagophobic coating assembly of claim 2, wherein the porosity comprises a discontinuous porosity

5. The pagophobic coating assembly of claim 1, wherein the wick comprises a hydrophilic or superhydrophilic material.

6. The pagophobic coating assembly of claim 1, wherein the wick comprises a nylon-based polymer.

7. The pagophobic coating assembly of claim 1, wherein the wick comprises at least one of a Poly(N-isopropylacrylamide) polymer, a Polyacrylamide based polymer, a Poly(2-oxazoline) based polymer, a Polyethylenimine based polymer, a Poly(acrylic acid) based polymer, an acrylic based polymer including a Polymethacrylate based polymer, a Poly(ethylene glycol) based polymer, a Poly(ethylene oxide) based polymer, a Poly(vinyl alcohol) based polymer, and a Poly(vinylpyrrolidone) based polymer.

8. The pagophobic coating assembly of claim 1, wherein the outer layer comprises a superhydrophobic or omniphobic material.

9. The pagophobic coating assembly of claim 1, wherein the outer layer comprises silicone or siloxane based polymer.

10. The pagophobic coating assembly of claim 1, wherein the outer layer comprises a fluorosilane based polymer.

11. The pagophobic coating assembly of claim 1, wherein the antifreeze material comprises an alkylene glycol.

12. The pagophobic coating assembly of claim 1, wherein the antifreeze material comprises at least one of a water soluble alcohol, a dicarboxylic acid, a salt of a dicarboxylic acid, and an antifreeze protein.

13. The pagophobic coating assembly of claim 1, wherein the first side is coupled to an outer surface of a substrate.

14. The pagophobic coating assembly of claim 1, wherein second side comprises the outer layer.

15. The pagophobic coating assembly of claim 1, wherein at least a portion of the wick layer is configured to enable the antifreeze material to migrate from the interior volume into the volume of the outer layer; and
wherein the outer layer is configured to enable the antifreeze to migrate to the upper surface.

16. An article of manufacture including a pagophobic coating comprising:
a good comprising an outer surface;
a wick layer coupled to the outer surface, the wick layer comprising an interior volume bounded by a first side and a second side;
an outer layer coupled to the wick layer, the outer layer comprising a volume bounded by a lower surface and an upper surface, the lower surface at least partially coupled to the second side; and
at least one fluid reservoir positioned in at least a portion of the wick layer, the at least one fluid reservoir including an antifreeze material; and
wherein the wick layer and outer layer are configured and arranged to enable the antifreeze material to migrate from the interior volume and through the volume of the outer layer to the upper surface.

17. A method of forming a pagophobic coating assembly comprising:
providing a wick layer comprising an interior volume including at least one fluid reservoir;
coupling an outer layer to the wick layer, the outer layer comprising a volume bounded by a lower surface and an upper surface, the lower surface at least partially coupled to the wick layer;
infusing an antifreeze material into the at least one fluid reservoir; and
wherein the wick layer is configured to enable the antifreeze material to migrate from the interior volume to the upper surface; and
wherein the antifreeze material can be resupplied using an active pumping device.

18. The method of claim 17, wherein the wick layer comprises a hydrophilic or superhydrophilic material and the outer layer comprises a superhydrophobic or omniphobic material.

19. The method of claim 18, wherein at least a portion of the outer layer is rendered hydrophilic when coupled with moisture comprising at least one of liquid water, frost, rime, and glaze.

20. The method of claim 19, wherein at least a portion of the wick layer is configured to enable at least a portion of the antifreeze material to migrate into any hydrophilic portion of the outer layer.
